(19) United States
(12) Patent Application Publication
(10) Pub. No.: US 2011/0040553 A1
(43) Pub. Date: Feb. 17, 2011

(54) NATURAL LANGUAGE PROCESSING

(76) Inventor: Sellon Sasivarman, Lappeenranta (FI)

Correspondence Address: FROMMER LAWRENCE & HAUG, 745 FIFTH AVENUE- 10TH FL., NEW YORK, NY, 10151, US

(21) Appl. No.: 12/514,644

(22) PCT Filed: Nov. 13, 2007
(86) PCT No.: PCT/FI2007/050610

§ 371 Date: Jun. 29, 2010

(30) Foreign Application Priority Data
Nov. 13, 2006 (FI) 20060995

(51) Int. Cl. G06F 17/27

(52) U.S. Cl. 704/9

(57) ABSTRACT

A method and system for computational interpretation of natural language, wherein in an input string is received from input means. The input string is first tokenizde for providing a list of words. Then the list of words is stemmed for providing the words in the root form. The stemmed list is then tagged for providing classification tags for each word, which allows generating the context sensitive information for each word. Lastly said tags are used for parsing the structural dependencies for each word.

### FIELD OF THE INVENTION

The invention relates to computational natural language processing.

### BACKGROUND OF THE INVENTION

Natural language processing (NLP) is a sub-field of artificial intelligence and linguistics. It studies the problems of automated generation and understanding of natural human languages. Natural language generation systems convert information from computer databases into normal-sounding human language, and natural language understanding systems convert samples of human language into more formal representations that are easier for computer programs to manipulate.

The field of natural language processing includes several different problems. These problems might be application dependent or relate to some particular language. One interesting problem is the interpretation of input texts. The interpretation is useful for example in proof reading and search engine applications. When the computer can interpret the meaning of the text correctly, it is possible to perform better proof reading and search results.

This interpretation is very difficult task. It requires a lot of resources and it is still difficult to provide correct interpretations of sentences. Previously statistical methods have been used for natural language processing.

Statistical natural language processing uses stochastic, probabilistic and statistical methods to resolve some of the difficulties discussed above, especially those which arise because longer sentences are highly ambiguous when processed with realistic grammars, yielding thousands or millions of possible analyses. Methods for disambiguation often involve the use of corpora and Markov models. The technology for statistical NLP comes mainly from machine learning and data mining, both of which are fields of artificial intelligence that involve learning from data.

One known and widely used learning based method is Brill Tagger by Eric Brill. Brill tagging is a kind of transformation-based learning. The general idea is very simple: guess the tag of each word, then go back and fix the mistakes. Thus, the Brill tagger is error-driven. In this way, a Brill tagger successively transforms a bad tagging of a text into a good one. This is a supervised learning method, since it needs annotated training data. It does not count observations but compiles a list of transformational correction rules.

The solution described above is efficient regarding to the quality of the result. However, as the problem of processing of the natural language is very comples, the suggested solution requires a lot of resources. Thus, there is a need for a solution that can provide appropriate results in very short time. This would allow the usage of natural language processing in further applications or to improve the quality by using more resources.

### SUMMARY

The invention discloses a method for computational interpretation of natural language, wherein in an input string is received from input means. Firstly, the input string is tokenized for providing a list of words. In tokenizing input character stream is split into meaningful symbols defined by a grammar of regular expressions.

Then the list of words is stemmed for providing the words in the root form. Stemming is a process for removing the commoner morphological and inflexional endings from words in English or other languages. Its main use is as part of a term normalisation process that is usually done when setting up information retrieval systems.

The stemmed list of words is then tagged for providing classification tags for each word. Then for each tagged word the context sensitive information is generated. With the context sensitive information the structural dependencies are parsed for each word.

The invention can be used in several different application fields for improving the computing efficiency and/or the quality of the output.

In an embodiment the present invention is used for content matching so that relevant content is suggested based on semantic relations. Possible content that semantic matching is most suitable for are events, reviews, news, discussion threads, guides and similar.

In an embodiment the present invention is used as a research tool. For example, a crawler type solution that finds usable and accurately relevant information on restricted subjects. The invention can be used first to gather the proper sources and then for gathering the needed information from those.

In an embodiment the present invention is used as semantic web production tools. For example, automatic suggesting of proper meta-data when using meta-data rich file formats such as RDF. This basically allows a tool to be created where the process of adding meta-data becomes much more process like. First the whole content is indexed and the level of detail in which meta-data will be added is defined. Then a streamlined process of adding the meta-data will start in a simplified, guided and straightforward manner.

In an embodiment the present invention is used as an online e-commerce Service. For example, product suggestion based on different criteria like product life-span where as semantic relation are used as the reference point. Being able to offer users with related products in different stages of the sales-cycle have been found extremely efficient by likes of Amazon.com and such. The problem so far has been the fact that it has taken vast resources since it has been heavily relying on manual inputting of the metadata. Even more important drawback of the prior art has been the fact that it only seems to be good, where as it is only script based, hence not really understanding what the user wants. With additional tool-sets, all products can be indexed, and with enough semantic relations in the knowledge base of the natural language processing, the results will be better.

In an embodiment the present invention is used in several different searching applications. In addition to conventional searches, the present invention can be used in, for example, ranking, question answering and summarizing. In summarizing the natural language processing is used in reverse. This is common approach in natural language production.

In an embodiment the present invention is used in voice/natural language commanding. Using natural language information retrieval technology, voice commanding application can be developed with higher tolerance to natural language. Furthermore, the present invention can be used in voice/natural language recognition. Natural language processing validation checking can perform much better than current dictionary based validation of user sentences.

In an embodiment the present invention is used in machine generated content/speech generation. For example, natural human like voice speech with text to speech application. Natural language processing can easily generate sentences that fill the perquisites of the content one intends to produce while still generating random sentences and structures.

The embodiments mentioned above can be combined in order to provide solutions that fulfill the requirements in human or natural language problems. Furthermore, the embodiments or any combination of them can be used in producing better artificial intelligence or expert systems that benefit from the better understanding of natural language.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow chart of a method according to the present invention,

FIG. 2 is a block diagram of an example embodiment of the present invention.

### DETAILED DESCRIPTION OF THE INVENTION

Reference will now be made in detail to the embodiments of the present invention, examples of which are illustrated in the accompanying drawings.

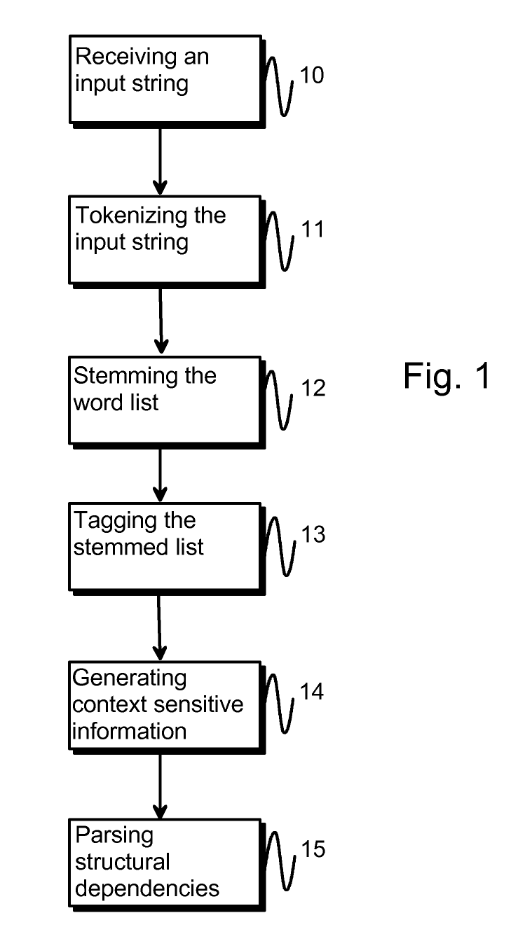

In FIG. 1 a flow chart of a method according to the present invention. The method according to the present invention is initiated by receiving an input string. The input string can be entered by using different types of input means, such as, a keyboard or voice recognition. According to the present invention, the input string is in written form. Thus, if a voice recognition or other input means are used, the input string may need to be converted into written form, step 10.

Then the input string is tokenized for providing a list of words, step 11. Person skilled in the art are familiar with tokenizing methods. It is recommended to use the Penn Treebank standard, as it is accepted by most other data sources.

Then the list of words is stemmed for providing the words in the root form, step 12. Stemming is a process for removing the commoner morphological and inflexional endings from words in English or other languages. Also stemming methods are known to a person skilled in the art. One recommended method is Porters Stemming method.

The stemmed list of words is then tagged for providing classification tags for each word, step 13. Then for each tagged word the context sensitive information is generated. With the context sensitive information the structural dependencies are parsed for each word. Also tagging methods are known to a person skilled in the art. One possible tagging method is to use Brill Tagger against the British National Corpus.

Even if the methods disclosed in the steps 11-13 are known to a person skilled in the art, they are necessary for the implementation of the invention. Furthermore, the implementation of the invention may require inventive modifications to the known methods.

In the present invention there are two sets of rules used, a set for tagging and another for syntactic parsing. These rules are all manually hand made, by studying the natural language specification, and in this example English.

The tagging rules are semi-iterative. Some of them are independent rules that apply the correct tags in a single run and some are dependent on further iterations of improvements. There are a determined number of needed iterations and this number is determined by a particular natural language specification (e.g. English). Each set of iteration consist of variable number of semi-iterative rules.

Each word is given the most probable or the only possible tag for the first iteration. In this step alone, most words are correctly tagged. These tags are collected from well known corpuses such as the British National Corpus. Certain words have tags that can be assigned well by looking at the first and last character of the word. Numbers are marked as numerals and capital letter words are made proper nouns and further rules will refine it to possessive form and so on.

After the first few steps, the rest are based on rules that have the following common forms:

| | |
|---|---|
| ! | not |
| ( ) | grouping |
| \| | or |
| & | and |
| [ ] | optional |
| * | 0 or more |
| \hat{ } | 1 or more |
| = | reference point to be assigned |
| :1 | refered point with number label |
| ‘’ | string literal |
| # | anything |
| } | anything in front are comments |
| { | anything behind are comments |
| @( ) | custom function |
| -> | if-then conditions |

Which lead into following example rules:

| | |
|---|---|
| ...} | |
| 9} | (DT\|J) =RB (V\|END) −> NN {the well, the big well |
| ...} | |
| 16} | :1(N\|IN\|DT\|J\|V&!@aux(V)) (N\|IN\|DT\|J\|V&!@aux(V))* |
| | [‘,’] CC =(NN\|NNS\|V\|J) −> :1\|VB\|VBG\|VBD\|VBZ |
| | {he likes singing and dancing |
| ...} | |
| 26} | (N\|RB) =IN (WDT\|DT\|N\|IN\|J\|RB) −> VBG\|VBZ\|VBP |
| | {he dances well, consumption rate rises |
| ...} | |

These rules haves if-then condition that replaces the reference point to be assigned in the rule with the given possible tags. Usually the condition result is a list of few different tags and a particular tag is applied when that tag is possible to be assigned to that word, in the order from left to right in the rule.

In total there are 30 unique rules such as these for tagging purpose and these rules are grouped in 5 different iterations. This order and arrangement is important and necessary for the tagging to perform well, but someone with enough knowledge would be able to change the order and grouping to differ from this technique without any changes in the rules itself.

Then for each tagged word the context sensitive information is generated, step 14. In the method of the example WordNet Database definitions/gloss is used to differentiate word context, in relation to other parts of sentence.

Lastly the the structural dependencies are parsed for each word, step 15. This is the most important part of the entire method. It structuralizes language, so that good logic representation can be done. For this to be done, three inputs are necessary, the tags of each word out of tagger, and the semantic id of each word out of disambiguater. Next, it uses the original sentence, the tags, and the semantic id as shown in the following table. The example input string is “The big brown dog, is drinking water at the river bank”.

| Tokenized | Stemmed | POS | Semantic ID |
|---|---|---|---|
| words | words | Tags | (Disambiguated) |
| The | the | +DET | 4324341 |
| Big | big | +ADJ | 6756234 |
| brown | brown | +ADJ | 3535243 |
| dog | dog | +NOUN | 6457745 |
| , | , | +CM | |
| Is | Be | +VBPRES | 2435435 |
| drinking | drink | +VPROG | 4523454 |
| water | water | +NOUN | 3454355 |
| At | At | +PREP | 9807889 |
| The | the | +DET | 4324342 |
| river | river | +NOUN | 8956888 |
| bank | bank | +NOUN | 2423423 |
| . | . | +SENT | |

Using rules build out of the words and POS tags, it is possible to produce desired result. Common words like ‘to’, ‘is’, ‘at’ in the sentence above brings relational meaning to the semantic id. Verbs tell actions, of nouns and the nouns are consisting of actors, places and timing as well.

Every single parsing step is hand coded, with very detailed language analysis that is done manually. Instead of grouping them in to NLP phrases such as plain verb phrase, noun phrase and so on, the invention aims grouping to subjects and predicates as it means in ordinary daily used language.

Thus, it is possible to produce following grouping for semantic ID's: 4523454 (6457745 [6756234, 3535243], 3454355 {2423423 [8956888]}).

The above semantically meaning the original sentence, and anything in the same meaning with the sentence, can be identified even if the structure of the other sentence is different. Some of the missing semantic ids are the special words recognized for the structural parsing itself or in other words those words are consumed for the tagging marks.

If the above is shown using the same word presentation of the words out of the sentence, it would be following: (drink (dog [big, brown], water {bank [river]}).

The result described above can be achieved with hand-written rules that do not need any learning capabilities. Thus, the implementation of the invention will be simpler and more resource efficient. For better understanding of the rule generation, some examples are given in the following list:

1. In the first version, rules are applied to specially tagged words.
a, to, with, is, an, e.g.

2. Detect structure that answers important questions based on previous tagging and special words.
where, why, who, what, when, how, e.g.

3. Detect handles logical relations
and, or, with, e.g.

4. Detect handles sentence connectors by rearranging sentence structure to a more appropriate one
with, that, which, e.g.

5. Specially mark up modifiers, adjectives and other parts of grammar to meaningful logic form
I want to buy a car which is blue→buy(I, blue[car]) (of course in sense ids)

6. Detect numerical values in form of numbers or words
9275 or ‘nine thousand two hundred seventy five’

7. All the above will be in the form of rules, and as unattached to the language specification as possible, that means the invention must not worry about the English grammar and tense at all. What the invention must look in to is just the sentence structure, and it's post tag, and get the relations between the sense. The invention does not implement an english language parser, but making a parser that is able extract the best out of English.

The second set of rules in the method described above is the syntatic parsing rules. These rules group the words of sentence together into meaningful phrases. These rules are as well hand made by studying language structure from semi-linguistic point of view. The semi-linguistic point of view means that, the parsing follows formal language forms and rules, and it also incorporates some informal style of the language that are commonly used in daily usage.

The following are some sample rules:

| | |
|---|---|
| ...} | |
| 2} | Av* (Av\|Aj) Aj* −> AP |
| ...} | |
| 13} | (NP ‘,’)* NP [‘,’] (‘and’\|‘or’) NP&!(PRP\|PRP$) −> |
| NP | |
| ...} | |
| 29} | (‘am’\|‘aren't’\|‘isn't’\|‘wasn't’\|‘are’\|‘is’\|‘was’\| |
| | ‘were’) [VBN\|VBG] −> VP |
| ...} | |

These rules have the same form and syntax as the previous tagging rules, but the if-then condition is meant to group the entire matching phrase with appropriate phrase symbols.

The rules are usually grouped, making the number of level produced in grouping tree mostly predictable. However, some of the grouped rules are recursive, hence produce multilevel grouping by applying a single rule repeatedly as the rule still match.

There are about 50 rules grouped in 10 groups. The orders of these rules are very important, as reordering these rules would entirely disable the parsing to run correctly.

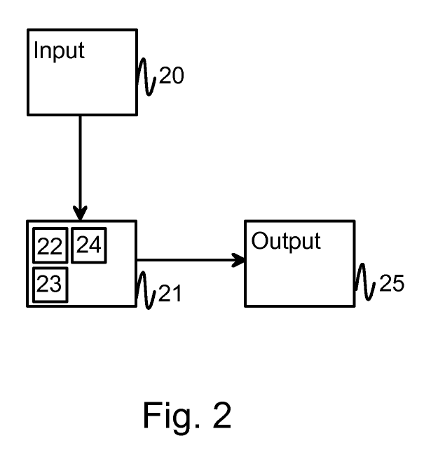

FIG. 2 discloses an example embodiment according to the present invention. In the embodiment of FIG. 2 the method described above is executed in a computing device that comprises an input 20, such as keyboard, microphone or similar, a central processing unit 21 and an output 25, such as a monitor, speaker system or similar. The output 25 may be a further computing system that takes the output of the system according to the present invention as an input. The central processing unit 21 comprises at least a processor 22 for processing the method according to the invention, a memory 23 for storing the data for the method and a mass storage device 24 for storing the databases needed by the invention.

The system described above may be, for example, an ordinary computer wherein the computer comprises a computer program arranged to perform the method described in FIG. 1.

It is obvious to a person skilled in the art that with the advancement of technology, the basic idea of the invention may be implemented in various ways. The invention and its embodiments are thus not limited to the examples described above; instead they may vary within the scope of the claims.

1. A method for computational interpretation of natural language, wherein in an input string is received from input means, the method comprising:
tokenizing the input string for providing a list of words; stemming the list of words for providing the words in the root form; and
tagging the stemmed list for providing classification tags for each word;
generating the context sensitive information for each word; and
parsing the structural dependencies for each word, wherein, wherein the parsing is based on said tags and context sensitive information.

2. The method according to claim 1, wherein the tagging is based on a semi-iterative process.

3. The method according to claim 2, further comprising assigning the most probable or the only possible tag for the first iteration.

4. The method according to claim 1, further comprising grouping in said parsing the entire matching phrase with appropriate phrase symbols.

5. The method according to claim 1, wherein said parsing is based on a set of rules arranged in a predetermined order.

6. A system for computational interpretation of natural language, wherein in an input string is received from input means, the system comprising:
input means;
central processing unit comprising a processor, a memory and a mass storage; and
output;
wherein the system is arranged to:
tokenize the input string for providing a list of words;
stem the list of words for providing the words in the root form; and
tag the stemmed list for providing classification tags for each word;
generate the context sensitive information for each word; and
parse the structural dependencies for each word, wherein, wherein the parsing is based on said tags and context sensitive information.

7. The system according to claim 6, wherein the system is arranged to tag based on a semi-iterative process.

8. The system according to claim 7, wherein the system is further arranged to assign the most probable or the only possible tag for the first iteration.

9. The system according to claim 6, wherein the system is further arranged to group in said parsing the entire matching phrase with appropriate phrase symbols.

10. The system according to claim 6, wherein said parsing is based on a set of rules arranged in a predetermined order.

11. A computer program embodied in a computer readable medium for computational interpretation of natural language, wherein in an input string is received from input means, which computer program is arranged to perform following steps when executed in a computing device:
tokenizing the input string for providing a list of words;
stemming the list of words for providing the words in the root form; and
tagging the stemmed list for providing classification tags for each word;
generating the context sensitive information for each word; and
parsing the structural dependencies for each word, wherein, wherein the parsing is based on said tags and context sensitive information.

12. The computer program according to claim 11, wherein the tagging is based on a semi-iterative process.

13. The computer program according to claim 12, further comprising assigning the most probable or the only possible tag for the first iteration.

14. The computer program according to claim 11, further comprising grouping in said parsing the entire matching phrase with appropriate phrase symbols.

15. The computer program according to claim 11, wherein said parsing is based on a set of rules arranged in a predetermined order.

16. A method for interpretation of natural language by a computer system that comprises an input means, a central processing unit that comprises a processor, a memory, and mass storage, and an output, wherein an input string is received from input means, the method comprising:
storing the input string in the memory;
executing instructions by the processor to cause the input string to be divided into one or more tokens, the tokens being stored in the memory as a list of one or more words;
executing instructions by the processor to cause each of the words in the list to be stemmed, stemming comprising identifying a root form for each of the words, each of the identified root forms being stored in the memory;
executing instructions by the processor to create one or more classification tags for each respective word, the classification tags being stored in the memory in association with each of the respective associated words;
executing instructions by the processor to generate context sensitive information for each word, the context sensitive information being stored in the memory; and
executing instructions by the processor to parse the structural dependencies for each word, wherein the parsing is based on said tags and context sensitive information.

17. The method according to claim 16, wherein creating the classification tags is based on a semi-iterative process.

18. The method according to claim 17, wherein creating the classification tags comprises assigning the most probable or the only possible tag for the first iteration.

19. The method according to claim 16, wherein parsing comprises grouping the entire matching phrase with appropriate phrase symbols.

20. The method according to claim 16, wherein said parsing is based on a set of rules arranged in a predetermined order.
